(19) United States
(12) Patent Application Publication
(10) Pub. No.: US 2022/0017173 A1
(43) Pub. Date: Jan. 20, 2022

(54) DECORATIVE MOLDED ARTICLE

(71) Applicant: Honda Motor Co., Ltd., Tokyo (JP)

(72) Inventors: Ikue SATO, Wako-shi, Saitama (JP); Hiroki SAKATA, Wako-shi, Saitama (JP); Kosaku MIZUTANI, Wako-shi, Saitama (JP)

(73) Assignee: Honda Motor Co., Ltd., Tokyo (JP)

(21) Appl. No.: 17/415,460

(22) PCT Filed: Dec. 17, 2019
(86) PCT No.: PCT/JP2019/049417

§ 371 Date: Jun. 17, 2021

(30) Foreign Application Priority Data
Dec. 18, 2018 (JP) 2018-236697

(51) Int. Cl. B62J 17/02; B29C 51/14

(52) U.S. Cl. CPC B62J 17/02; B29L 2031/3041; B29C 51/14

(57) ABSTRACT

A decorative molded article includes a resin-made base body and a resin-made skin body. The base body includes a skeleton body spread in a mesh pattern along a matching surface, and singly has rigidity lower than intended rigidity. The skin body includes a colored printed surface. The skin body is fixed to the base body so as to cover the matching surface. The skin body secures the intended rigidity in cooperation with the base body. The thus-provided decorative molded article includes the decorative sheet with a function of reinforcing rigidity, and thereby enables the decorative sheet to contribute to a decrease in resin amount.

### FIELD

The present invention relates to a decorative molded article including a base body and a skin body. The skin body includes a decoratively colored surface, and is fixed to an outer surface of the base body so as to cover the outer surface.

### BACKGROUND

Patent Literature 1 discloses a manufacturing method for covering a molded article body with a decorative sheet (sheet for decoration) to manufacture a decorative molded article. The molded article body singly has rigidity intended as that for a product. An adhesive sheet is superposed on and fixed to an outer surface of the molded article body, for decoration. The adhesive sheet serves to form an adhesive layer on the outer surface of the molded article body. The decorative sheet is superposed on the adhesive layer. The adhesive layer serves to fix the decorative sheet to the outer surface of the molded article body.

### CITATION LIST

### Patent Literature

Patent Literature 1: International Publication No. WO 2007/013292

### BRIEF SUMMARY

### Technical Problem

The decorative sheet functions as decoration and a protection film. The decorative sheet does not contribute to securing rigidity. Accordingly, a resin amount of the decorative molded article increases depending on addition of the decorative sheet.

This leads to a weight increase of the decorative molded article.

The present invention has been made in view of the above-described circumstances. An object of the present invention is to provide a decorative molded article that includes a decorative sheet with a function of reinforcing rigidity and that thereby enables the decorative sheet to contribute to a decrease in resin amount.

### Solution to Problem

A first aspect of the present invention provides a decorative molded article including:

a resin-made base body that includes a skeleton body spread in a mesh pattern along a matching surface, the base body singly having rigidity lower than intended rigidity; and

a resin-made skin body that includes a colored printed surface, and is fixed to the base body so as to cover the matching surface, the skin body securing the intended rigidity in cooperation with the base body.

According to a second aspect, in addition to the configuration of the first aspect, the base body includes a shell body that spreads along the matching surface so as to occupy an in-between space in the skeleton body, and the skin body has a thickness equal to or larger than a thickness of the shell body.

According to a third aspect, in addition to the configuration of the first or second aspect, the skeleton body is arranged at a first density in a first region for which a first rigidity is intended, and is arranged at a second density in a second region for which a second rigidity is intended, the second density being higher than the first density, the second rigidity being higher than the first rigidity.

According to a fourth aspect, in addition to the configuration of the third aspect, the base body includes a pedestal in the second region, the pedestal having a thickness larger than a thickness of the skeleton body and having an area wider than the skeleton body, along the matching surface.

According to a fifth aspect, in addition to the configuration of any one of the first to fourth aspects, the skin body is a layer body that is adhered, with an adhesive, to the matching surface of the base body.

According to a sixth aspect, in addition to the configuration of the fifth aspect, the layer body is molded from a resin sheet that is made to cover the matching surface by thermoforming.

### Advantageous Effects

According to the first aspect, the skin body is fixed to and integrated with the matching surface of the base body so as to cover the matching surface. The skin body and the base body secure the intended rigidity, as a whole. The skin body contributes to rigidity of the decorative molded article. Since the skin body contributes to securing the rigidity, a resin amount of the decorative molded article is reduced by at least an amount of a generally used decorative film. A weight of the decorative molded article is reduced.

According to the second aspect, the shell body imparts rigidity to the skeleton body. Accordingly, the skeleton body can have a reduced thickness, along the matching surface. The decorative molded article can have a reduced thickness.

According to the third aspect, coarseness and fineness of the mesh can be adjusted depending on the locally intended rigidity. The rigidity intended for each region can be secured.

According to the fourth aspect, when a component is coupled to the pedestal, the pedestal is intended to have rigidity capable of withstanding support of the component. The intended rigidity can be secured while depending on coarseness and fineness of ribs.

According to the fifth aspect, the skin body can be formed as the layer body adhered to the matching surface. The skin body can be easily molded in conformity with the matching surface.

According to the sixth aspect, thermoforming is used in molding the decorative molded article. The skin body can be easily molded from the resin sheet.

### BRIEF DESCRIPTION OF DRAWINGS

FIG. 1 schematically illustrates an entire appearance of a motorcycle (saddle-type vehicle) according to one embodiment of the present invention.

FIG. 2 is an enlarged perspective view schematically illustrating a configuration around a front cowl.

FIG. 3 is a sectional view taken along the 3-3 line in FIG. 1, and illustrates a structure for coupling between a front center cowl and a vehicle-body-frame side.

FIG. 4 is a sectional view taken along the 4-4 line in FIG. 2, and illustrates a structure for coupling between a front side cowl and a vehicle-body-frame side.

FIG. 5 is a sectional view taken along the 5-5 line in FIG. 2, and illustrates structures of the front center cowl and a visor.

FIG. 6 is a skeleton structure diagram (making an outer surface transparent) illustrating arrangement of a skeleton body.

FIG. 7 is an enlarged plan view schematically illustrating a structure of a skeleton body according to a modified example.

FIG. 8 is an enlarged perspective view schematically illustrating a pedestal for a direction indicator.

FIG. 9 is an exploded perspective view of the front cowl.

FIG. 10 is a partially enlarged perspective view illustrating an arrangement structure of convex portions fitted to ribs.

FIG. 11 is an enlarged sectional view illustrating the convex portions fitted into concave portions surrounded by the ribs.

FIG. 12 is a partially enlarged perspective view schematically illustrating a structure of convex portions according to a modified example.

FIG. 13 is an enlarged perspective view of side cowls and a rear cowl.

FIG. 14 is a sectional view taken along the 13-13 line in FIG. 1, and illustrates an attachment structure of the rear cowl.

FIG. 15 is a plan view illustrating a configuration of a decorative sheet.

FIG. 16A to FIG. 16D are concept diagrams schematically illustrating a method for manufacturing the front center cowl by a thermoforming apparatus.

FIG. 17 is an enlarged perspective view illustrating a base body included in the front center cowl with a bead edge of the visor.

FIG. 18 is an enlarged sectional view taken along the 17-17 line in FIG. 16A.

FIG. 19A to FIG. 19C are concept diagrams schematically illustrating a method for manufacturing the front center cowl by press molding and integral injection molding.

FIG. 20A to FIG. 20C are concept diagrams schematically illustrating a method for manufacturing the front center cowl by vacuum molding and insert injection molding.

FIG. 21 is a skeleton structure diagram (making an outer surface transparent) illustrating arrangement of ribs in a front cowl according to another embodiment.

FIG. 22 is an enlarged sectional view taken along the 22-22 line in FIG. 21.

### REFERENCE SIGNS LIST

23a Decorative molded article (front center cowl)
25b Decorative molded article (front side cowl)
24 Decorative molded article (side cowl)
25 Decorative molded article (rear cowl)
46 Pedestal
51 Skeleton body
52 Base body
53 Skin body
54 Shell body
57 Adhesive
61a First region
61b Second region
64a First region
64b Second region
S Matching surface

### DETAILED DESCRIPTION

The following describes an embodiment of the present invention with reference to the accompanying drawings. Hereinafter, “up”, “down”, “front”, “rear”, “left”, and “right” of a vehicle body are stated from the standpoint of a sight line of an occupant riding on a motorcycle.

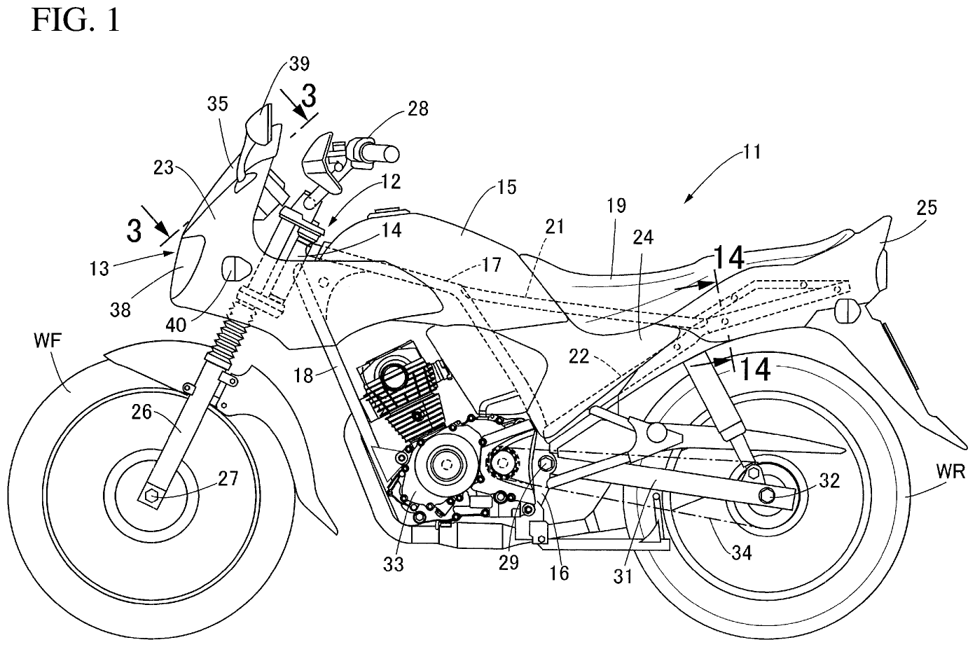

FIG. 1 schematically illustrates an entire appearance of a motorcycle that is a saddle-type vehicle according to one embodiment of the present invention. The motorcycle 11 includes a body frame 12 and a cowl 13 attached on the body frame 12. The vehicle body frame 12 includes a head pipe 14, a main frame 17, a down frame 18, and a rear frame 22. The main frame 17 extends to a lower rear side from the head pipe 14 and supports a fuel tank 15. The main frame 17 includes a pivot frame 16 at its lower rear end. The down frame 18 extends, at a position below the main frame 17, downward from the head pipe 14. The rear frame 22 is connected to the rear end of the main frame 17. The rear frame 22 extends to an upper rear side to be connected to a seat rail 21. The seat rail 21 supports an occupant seat 19. The rear frame 22 supports the seat rail 21 from below.

The cowl 13 includes a front cowl 23, a side cowl 24, and a rear cowl 25. The front cowl 23 covers the head pipe 14 from a front side. The side cowl 24 continuously covers a region on a lateral side of the seat rail 21, in a range from lower ends of the fuel tank 15 and the occupant seat 19. The rear cowl 25 is on a rear side of the side cowl 24, and continuously covers a region on a rear side of the seat rail 21, in a range from the lower end of the occupant seat 19. Outer surfaces of the front cowl 23, the side cowl 24, and the rear cowl 25 are colored.

The head pipe 14 supports a front fork 26 so as to be freely steerable. The front fork 26 supports a front wheel WF so as to be freely rotatable around an axle 27. A steering handle 28 is coupled to an upper end of the front fork 26.

A swing arm 31 is connected, on a rear side in the vehicle, to the vehicle body frame 12 so as to be freely swingable up and down around a pivot 29. The swing arm 31 includes a rear end that supports a rear wheel WR so as to be freely rotatable around an axle 32. A power unit 33 is mounted, between the front wheel WF and the rear wheel WR, on the vehicle body frame 12. The power unit 33 generates driving force transmitted to the rear wheel WR. Power of the power unit 33 is transmitted to the rear wheel WR via a power transmission device 34.

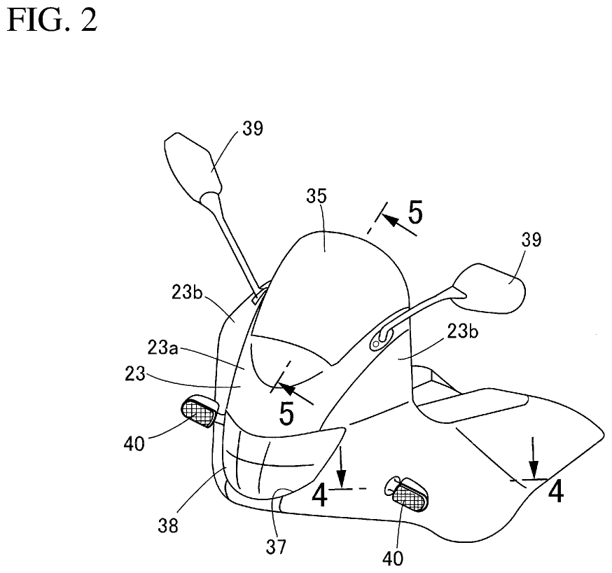

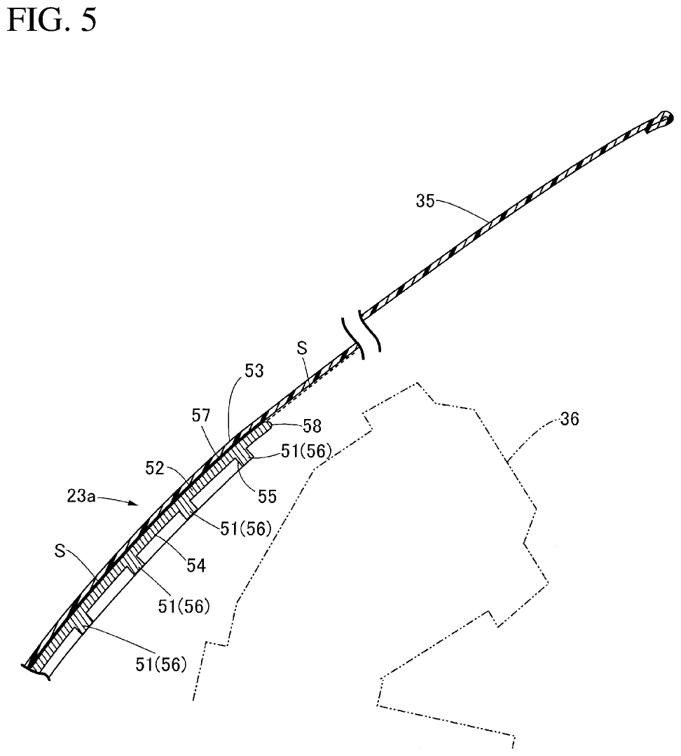

A visor (windscreen) 36 is attached to the front cowl 23 as illustrated in FIG. 2. The visor 35 spreads from an upper edge of the front cowl 23 and covers, from a front side, a space above the head pipe 14. The visor 35 covers instruments 36 as illustrated in FIG. 5. The instruments 36 are fixed to the front cowl 23 so as to be positioned on a front side of the head pipe 14 and on a rear side of the visor 35.

A headlight 38 is attached at an opening 37 of the front cowl 23. The opening 37 is positioned, below the visor 35, at a center of the front cowl 23, and is open to a front side of the vehicle body. The headlight 38 is provided for illuminating a front side of the vehicle in response to supply of electric power. Rear view mirrors 39 are fixed to the front cowl 23. The rear view mirrors 39 extend upward from left and right sides of the visor 35. The rear view mirrors 39 enable a driver to check a rear view. Direction indicators 40 are fixed to the front cowl 23, at positions somewhat separated to a rear side of the vehicle body from both left and right sides of the headlight 38. The direction indicators 40 extend outward in horizontal directions. The direction indicators 40 are turned on in response to switch operation of a driver.

The front cowl 23 includes a front center cowl 23a and front side cowls 23b. The front center cowl 23a surrounds the headlight 38 to support the visor 35. The front side cowls 23b are coupled to left and right portions of the front center cowl 25a. The rear view mirrors 39 are fixed to the front center cowl 23a. The direction indicators 40 are fixed to the front side cowls 23b.

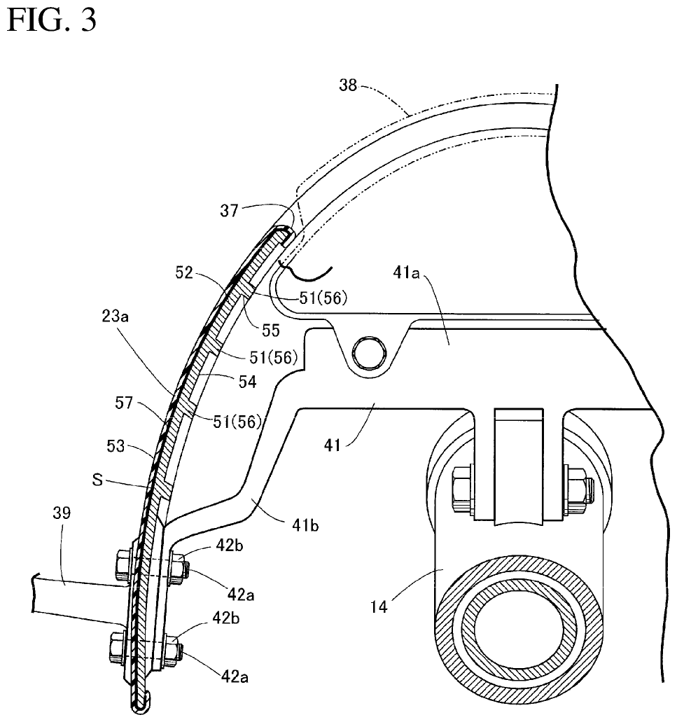

A headlight stay 41 is coupled to the head pipe 14 as illustrated in FIG. 3. The headlight stay 41 supports the headlight 38. The headlight stay 41 includes a horizontal body 41a and upward bodies 41b. The horizontal body 41a, which is coupled to the head pipe 14, extends horizontally on a front side of the head pipe 14. The upward bodies 41b extend upward from left and right ends of the horizontal body 41a. The headlight 38 is attached to the horizontal body 41a. The front center cowl 23a and the rear view mirror 39 are fastened together to an upper end of the upward body 41b, with bolts 42a and nuts 42b. The front center cowl 23a is fixed to the headlight stay 41, at positions including at least two left and right positions.

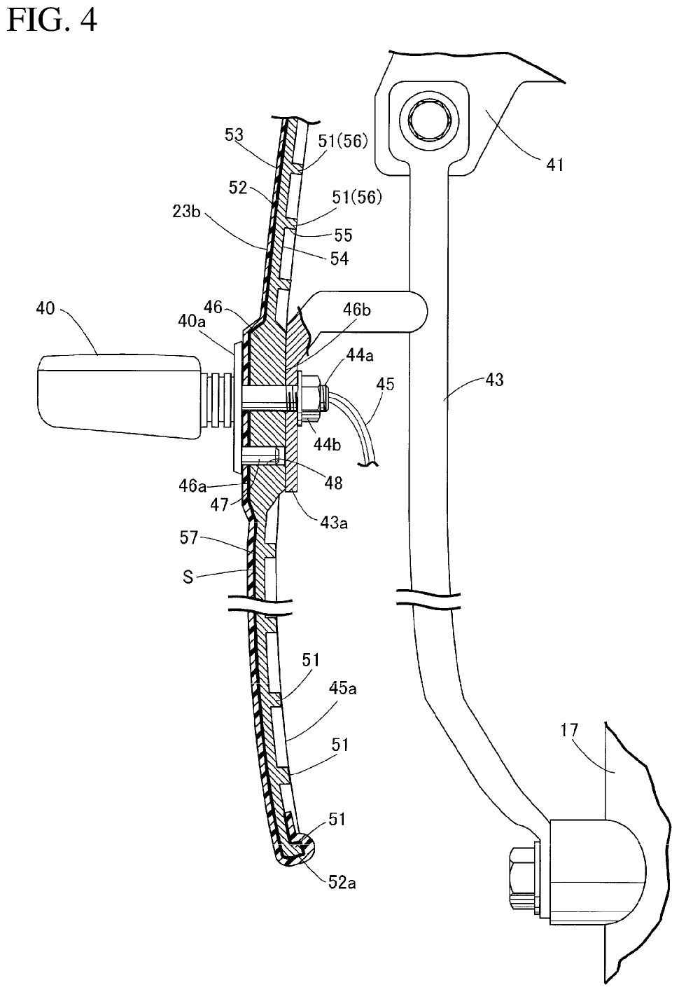

Direction-indicator stays 43 extend in a front-rear direction at positions separated from the head pipe 14 to the left and right sides, as illustrated in FIG. 4. The direction-indicator stay 43 includes a front end coupled to the horizontal body 41a of the headlight stay 41. The direction-indicator stay 43 includes a rear end coupled to the main frame 17. A bolt 44a extends from the direction indicator 40. The front side cowl 23b and the direction-indicator stay 43 are fastened together to the bolt 44a, with a nut 44b. A wiring 45 for the direction indicator 40 is inserted into the bolt 44a and pulled out. The left and right front side cowls 23b and 23b are individually fixed to the direction-indicator stays 43 and 43.

A pedestal 46 is formed at the front side cowl 23b. The pedestal 46 swells from an outer surface of the front side cowl 23b and supports the direction indicator 40. A flat attachment surface 46a is formed on the pedestal 46. The attachment surface 46a receives an attachment plate 40a of the direction indicator 40. The bolt 44a penetrates through the pedestal 46. A rotation stop pin 47 is formed on the attachment plate 40a, at a position separated from the central axis of the bolt 44a. The rotation stop pin 47 extends parallel to the bolt 44a. The rotation stop pin 47 is fitted into a penetration hole 48 formed in the pedestal 46. The rotation stop pin 47 serves to prevent the direction indicator 40 from rotating around the axis of the bolt 44a.

A flat reception surface 46b is formed on the pedestal 46, on a back side of the attachment surface 46a. The reception surface 46b receives an attachment plate of the direction-indicator stay 43. The attachment plate 43a of the direction-indicator stay 43 is superposed on the reception surface 46b. The attachment plate 43a is fastened to the pedestal 46 with the nut 44b.

The front center cowl 23a includes a base body 52 and a skin body 53 as illustrated in FIG. 5. The base body 52 includes a skeleton body 51 spread in a mesh pattern along a matching surface S. The base body 52 singly has rigidity lower than intended rigidity. The skin body 53 includes a colored printed surface. The skin body 53 is fixed to the base body 52 so as to cover the matching surface S. The skin body 53 secures the intended rigidity in cooperation with the base body 52. The base body 52 is molded from a resin material. An example used as the molding is injection molding. Since an outer surface of the base body 52 is covered with the skin body 53, the base body 52 does not need to be surface-treated after the molding.

The base body 52 includes a shell body 54 spreading along the matching surface S so as to occupy in-between spaces in the skeleton body 51. The shell body 54 is equivalent to a shell formed in conformity with an external shape of the front center cowl 23a. The shell body 54 can be formed in a uniform thickness, for example. The shell body 54 has a thickness of 0.6 to 1.0 mm, for example.

The shell body 54 occupies the in-between spaces in the skeleton body 51. Thereby, the skeleton body 51 functions as ribs 56 intersecting with each other in the mesh pattern and forming concave portions 55 open inward. The ribs 56 each protrude by a predetermined height from an inner surface of the shell body 54. The ribs 56 are each set so as to have a thickness of 0.8 to 1.0 mm, for example, and each have a height of 1.0 to 5.0 mm, for example.

The skin body 53 may be formed of a thermoplastic resin material such as polycarbonate resin, polyethylene resin, or an ABS resin material. The skin body 53 may be formed of a material same as or different from resin materials of the skeleton body 51 and the base body 52. The skin body 53 may be formed of polycarbonate resin having transparency. Alternatively, the skin body 53 may be formed of an opaque material. An outer surface of the skin body 53 is colored with ink by printing. The coloring may be patterned. Alternatively, an inner surface of the skin body 53 may be colored with ink by printing. In this case, the skin body 53 is transparent so that the coloring of the inner surface comes to appear on the outer surface of the skin body 53. In each of the cases, the coloring visually appears on the outer surface of the front center cowl 23a. The skin body 53 has a thickness equal to or larger than that of the shell body 54. The skin body 53 has a thickness larger than 1.0 mm, for example. The skin body 53 has rigidity for maintaining its shape in the case of being singly molded.

An adhesive 57 is laid between the skin body 53 and the matching surface S of the base body 52. Accordingly, the skin body 53 is a layer body that is adhered, with the adhesive 57, to the matching surface S of the base body 52. The skin body 53 is integrated with the base body 52, with the adhesive 57. The layer body is molded from a resin sheet that is made to cover the matching surface S by thermoforming, as described below.

The base body 52 includes a through-hole portion 58. The through-hole portion 58 is defined along the matching surface S so as to adjoin the shell body 54. The visor 35 covers the through-hole portion 58 continuously from the skin body 53. The skin body 53 is adhered to the shell body 54 so as to cover the matching surface S. The visor 35 spreads outward from the base body 52, and singly maintains its shape. The visor 35 is molded from a resin sheet that is made to cover the through-hole portion 58 at the matching surface S by thermoforming, as described below. The visor 35 is colored in a sunshade color, for example. The front center cowl 23a and the visor 35 form a seamlessly continuous outer surface.

The skin body 53 is wrapped around an edge 52a of the base body 52 at the edge of the base body 52, as illustrated in FIG. 4. The edge 52a of the base body 52 is thus covered with the skin body 53. The edge 52a of the base body 52 may be defined by the rib 51.

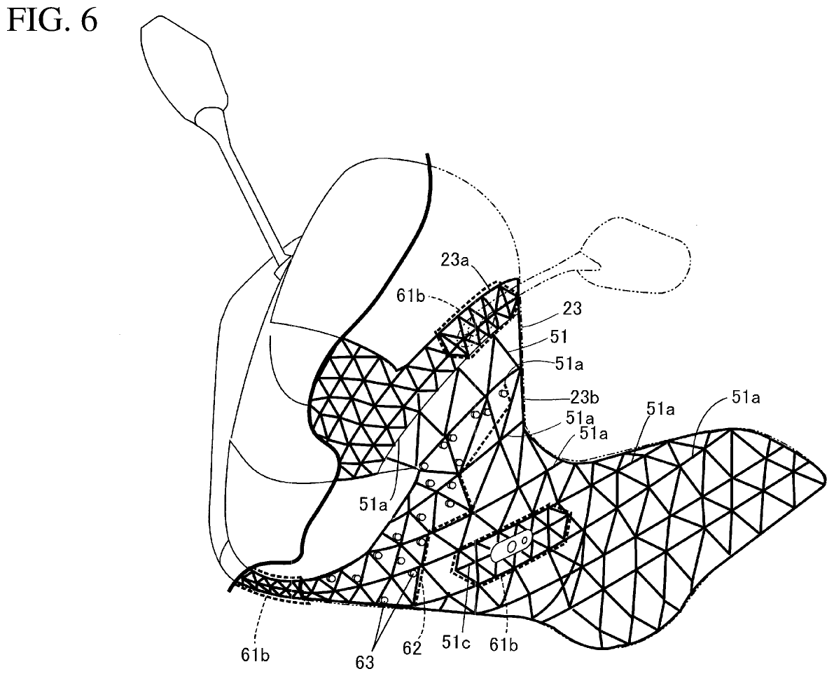

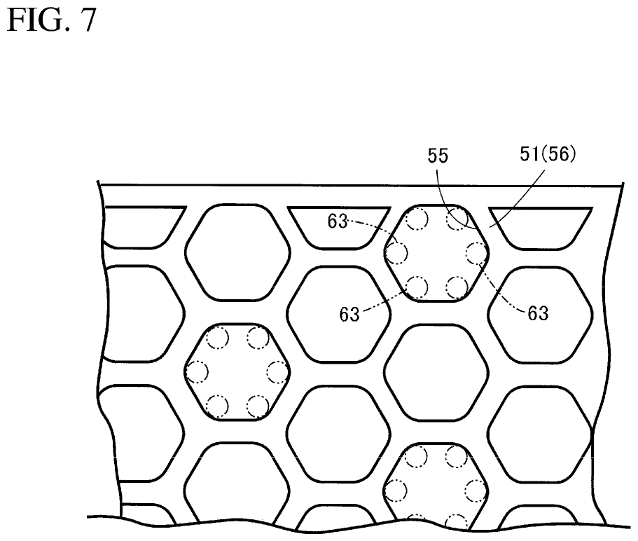

The front side cowl 23b includes a resin-made base body 52 and a resin-made skin body 53 as illustrated in FIG. 6, similarly to the front center cowl 23a. The base body 52 includes a skeleton body 51 spread in a mesh pattern along a matching surface S. The base body 52 singly has rigidity lower than intended rigidity. The skin body 53 includes a colored printed surface. The skin body 53 is fixed to the base body 52 so as to cover the matching surface S. The skin body 53 secures the intended rigidity in cooperation with the base body 52. The skeleton bodies 51 in the front center cowl 23a and the front side cowl 23b are each formed in a triangular truss pattern along the matching surface S, for example. A plurality of ribs 56 define triangular concave portions 57 along the inner surface of the shell body 54. The skeleton body 51 includes reference lines 51a in the case of formation of the truss pattern. The reference lines 51a extend back and forth in a predetermined direction. Alternatively, the skeleton body 51 may have a honeycomb shape continuous in a hexagon, as illustrated in FIG. 7.

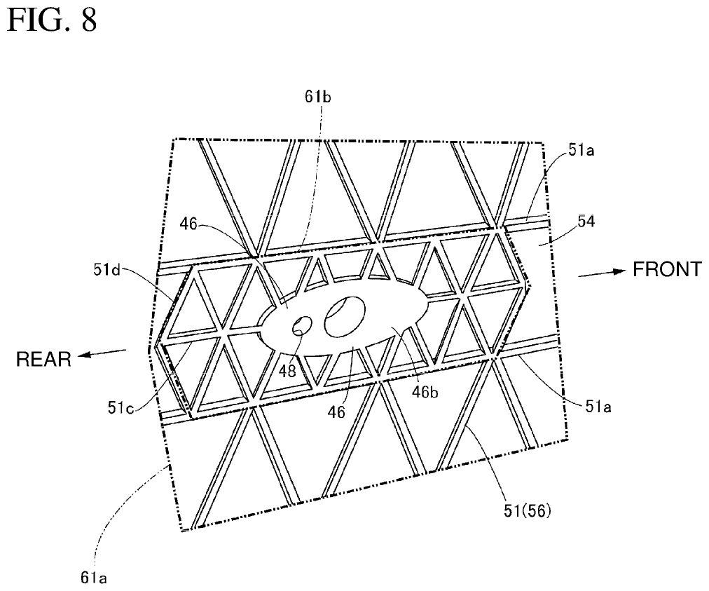

The base body 52 includes a first region 61a for which a first rigidity is intended, and a second region 61b for which a second rigidity is intended, as illustrated in FIG. 8. The second rigidity is higher than the first rigidity. The intended rigidity is set at a stage of designing the front center cowl 23a and the front side cowl 23b. The base body 52 of the front side cowl 23b includes the above-described pedestal 46 in the second region 61b. The pedestal 46 is at an intermediate position in the concave region sandwiched between the reference lines 51a positioned above and below the pedestal 46. Fine triangular skeleton bodies 51c and 51d continuous from joints with the pedestal 46 are provided in standing postures. A height of the pedestal 46 is equal to a height of the ribs 56. The pedestal 46 and the ribs 56 are continuous with each other at the same plane. The pedestal 46 has a thickness larger than a thickness of the skeleton body 51, as illustrated in FIG. 4. The pedestal 46 has an area (spread) wider than the skeleton body 51, along the matching surface S, as illustrated in FIG. 8. The skeleton body 51 is arranged at a first density in the first region 61a, and is arranged at a second density in the second region 61b. The second density is higher than the first density. A density of the skeleton body 51 may gradually increase as a position shifts from the first region 61a to the second region 61b. In such a manner, coarseness and fineness of the mesh is adjusted depending on locally intended rigidity.

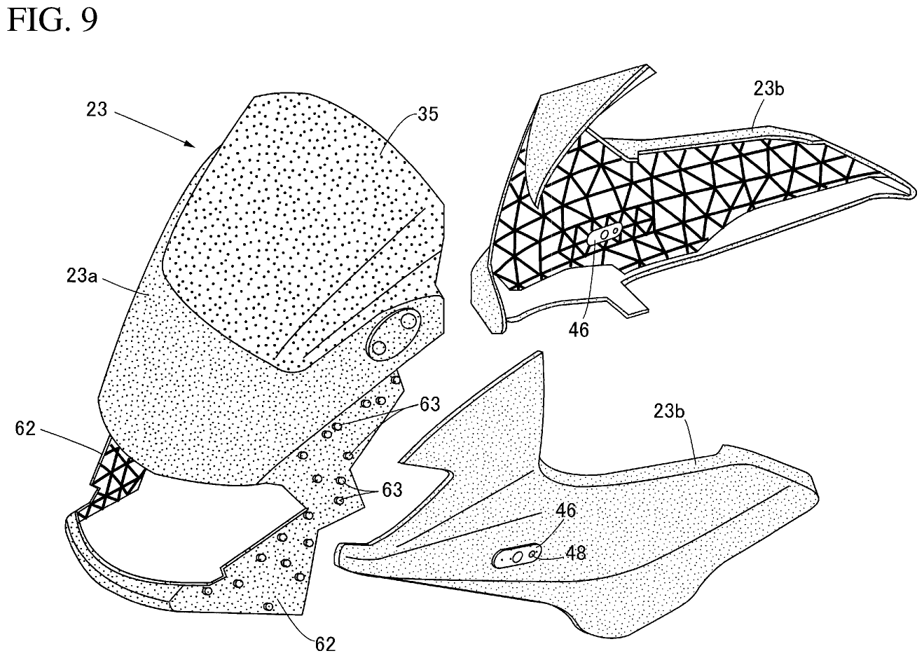

Support plates 62 are formed at the front center cowl 23a, as illustrated in FIG. 9. The support plate 62 receives the front side cowl 23b. An inner surface of the front side cowl 23b is superposed on an outer surface of the support plate 62. The front side cowl 23b is coupled to the front center cowl 23a. An outer surface of the front side cowl 23b is continuous with an outer surface of the front center cowl 23a, at the same plane. A plurality of convex portions 63 are formed on the outer surface of the support plate 62 so as to protrude from the outer surface, at positions separated from each other. The convex portions 63 are fitted into the polygonal concave portion 58 that is surrounded by the ribs 56 inside the front side cowl 23b.

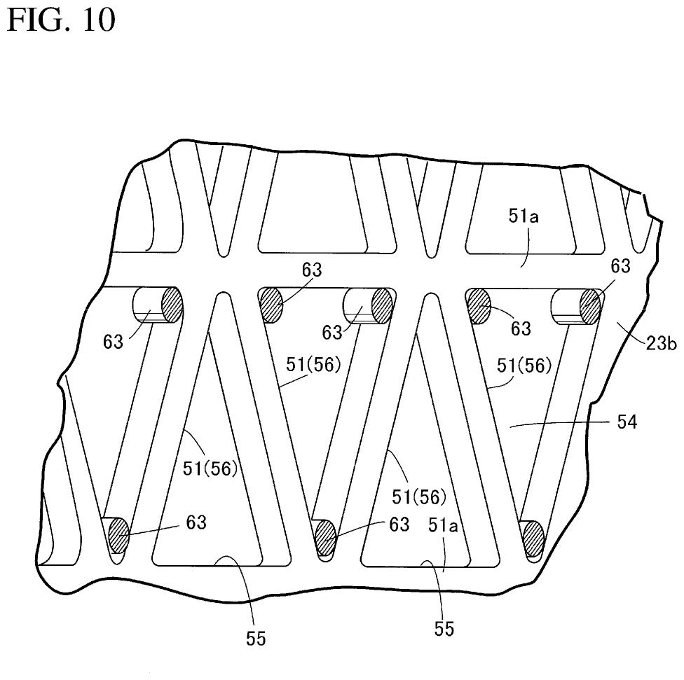

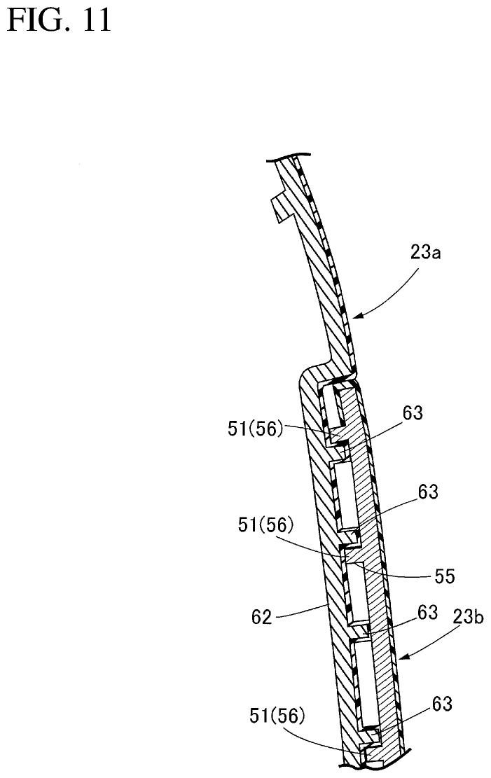

The convex portion 63 is arranged at a corner of the concave portion 58 defined by the ribs 56, as illustrated in FIG. 10 and FIG. 11. The convex portion 63 is sandwiched between mutually facing surfaces of the ribs 56 by use of elastic deformation of the resin. The convex portion 63 is formed in a cylindrical shape, for example. The convex portion 63 is pressed against and in contact with the ribs 56 in a state of being inserted into the concave portion 55. Here, the convex portions 63 contacting with the upper and lower reference lines 51a from inside restrain the front side cowl 23b and the front center cowl 23a from being displaced relative to each other in the up-down direction. In addition, the convex portions 63 contacting, from inside, with a plurality of the ribs 51 that connect the upper and lower reference lines 51a to each other restrain the front side cowl 23b and the front center cowl 23a from being displaced relative to each other in a horizontal direction perpendicular to the up-down direction.

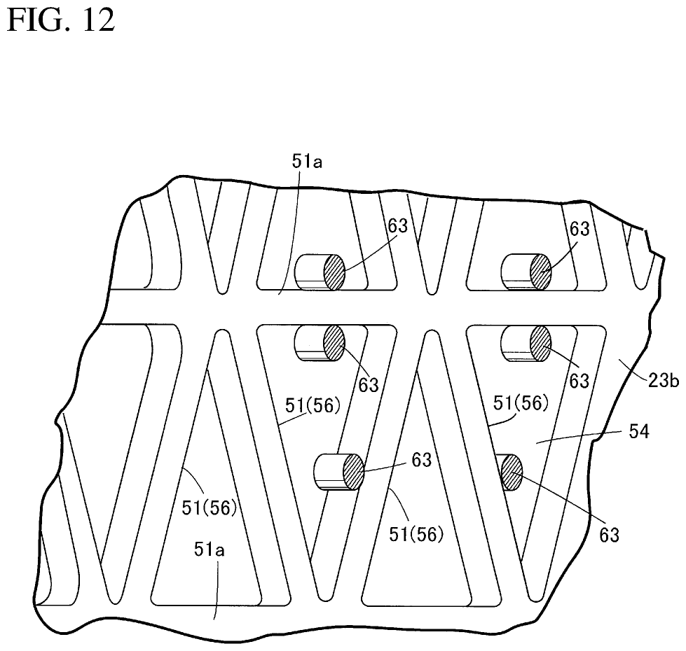

Alternatively, both side surfaces of the rib 56 may be sandwiched by the convex portions 63 and 63 arranged at an interval of a thickness of the rib 56, as illustrated in FIG. 12. The convex portions 63 form a pair pressed against and in contact with the rib 56 in a state of sandwiching the rib 56. Here, the two convex portions 63 contacting with the one reference line 51a from above and below restrain the front side cowl 23b and the front center cowl 23a from being displaced relative to each other in the up-down direction. In addition, the two convex portions 63 contacting with the mutually neighboring ribs 56 from outside restrain the front side cowl 23b and the front center cowl 23a from being displaced relative to each other in a horizontal direction perpendicular to the up-down direction. The ribs 56 between the reference lines 51a make an intersection angle smaller than 90 degrees. The intersection angle is used so that the wedge using elastic deformation of the resin serves to attach the convex portions 63 to the ribs 56 by the pressure.

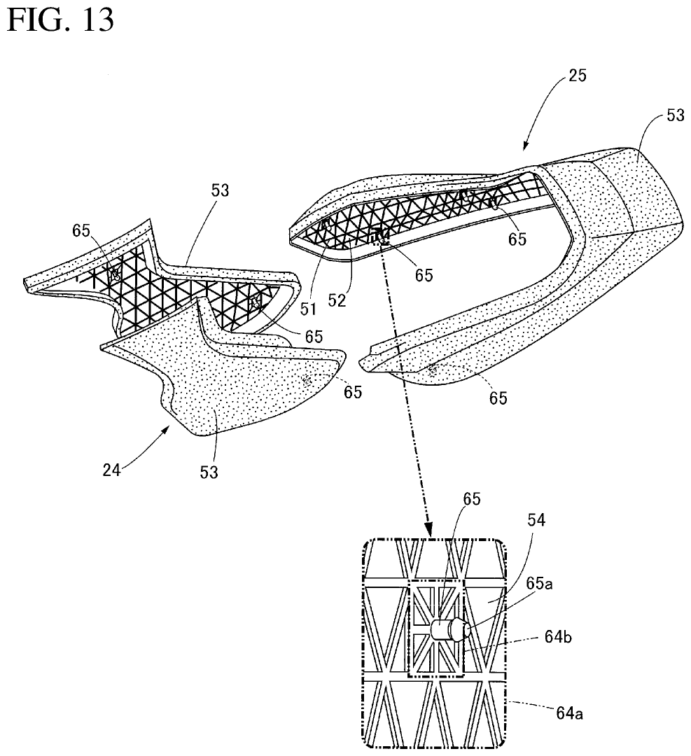

The left and right side cowls 24 and 24 and the rear cowl 25 each include a resin-made base body 52 and a resin-made skin body 53 as illustrated in FIG. 13, similarly to the front center cowl 23a. The base body 52 includes a skeleton body 51 spread in a mesh pattern along a matching surface S. The base body 52 singly has rigidity lower than intended rigidity. The skin body 53 includes a colored printed surface. The skin body 53 is fixed to the base body 52 so as to cover the matching surface S. The skin body 53 secures the intended rigidity in cooperation with the base body 52. The base body 52 includes a first region 64a for which a first rigidity is intended, and a second region 64b for which a second rigidity is intended. The second rigidity is higher than the first rigidity.

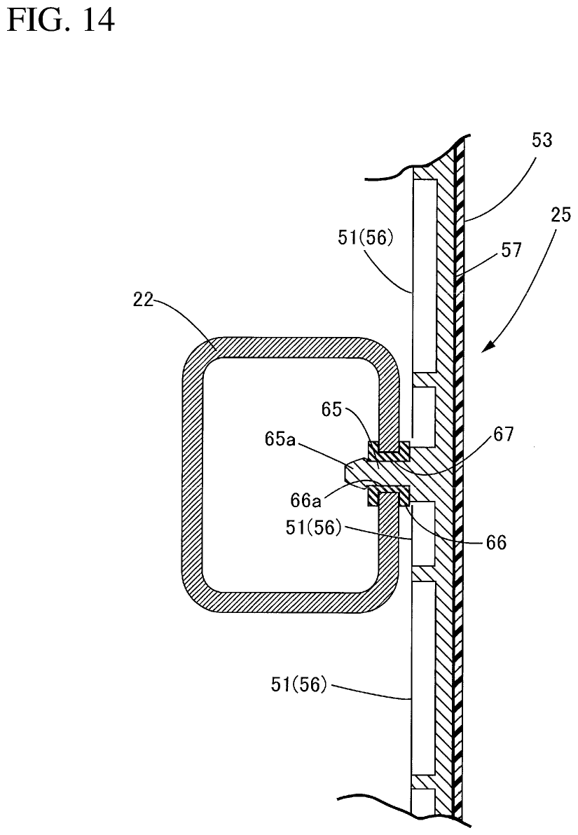

The base body 52 of the rear cowl 25 includes a cylindrical projection 65 in the second region 64b. The projection 65 protrudes inward. An umbrella-shaped engagement end 65a is formed at a distal end of the projection 65. The engagement end 65a includes a step surface facing a shell body 54, so as to expand in a radial direction. The engagement end 65a is tapered toward the distal end. The left and right side cowls 24 and 24 and the rear cowl 25 are each attached to the vehicle body frame 12 by an attachment structure. The attachment structure includes the projection 65 and an elastic rubber grommet 66 as one example, as illustrated in FIG. 14. The distal end of the projection 65 is inserted into an insertion hole 66a of the grommet 66 held by the rear frame 22. The grommet 66 is fitted, by use of the elastic deformation, into a penetration hole 67 formed in the rear frame 22. The tapered engagement end 65a advances into the insertion hole 66a while using the elastic deformation of the grommet 66. The step surface of the engagement end 65a serves to prevent the projection 65 from being detached from the penetration hole 67. The rear cowl 25 is thus attached to the rear frame 22. The skeleton body 51 is arranged at a first density in a normal first region 64a, and is arranged at a second density in a second region 64b. The second density is higher than the first density. The second region 64b as an attachment portion is arranged at a position facing a flat surface formed on a side surface of the rear frame 22. The flat surface serves to receive the ribs 51 and stop deflection of the rear cowl 25 when the grommet 66 and the rear cowl 25 are elastically deformed.

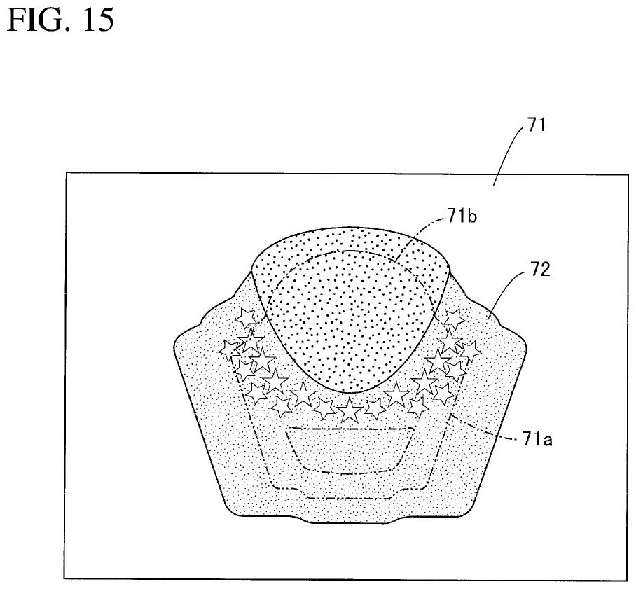

Next, a method for manufacturing the cowl 13 is described in outline. Here, a method for manufacturing the front center cowl 23a and the visor 35 is described as a representative. Since the front side cowl 23b, the side cowl 24, and the rear cowl 25 are manufactured similarly to the front center cowl 23a, manufacturing of the front center cowl 23a is described as one example. First, a decorative sheet 71 for the front center cowl 23a is prepared as illustrated in FIG. 15. The decorative sheet 71 includes an outer surface region 71a of the front center cowl 23a, and an outer surface region 71b as a portion becoming the visor 35. Coloring 72 is printed on the outer surface regions 71a and 71b, with ink or the like. Here, the printing includes the case of applying paint while using a template for masking, and the case of applying ink by a printing robot such as an inkjet one. The coloring includes a single color, a plurality of colors, and a design pattern. Here, the coloring 72 is applied to a region wider than the outer surface regions 71a and 71b, in consideration of the wraparound of the decorative sheet 71 and a trimming allowance.

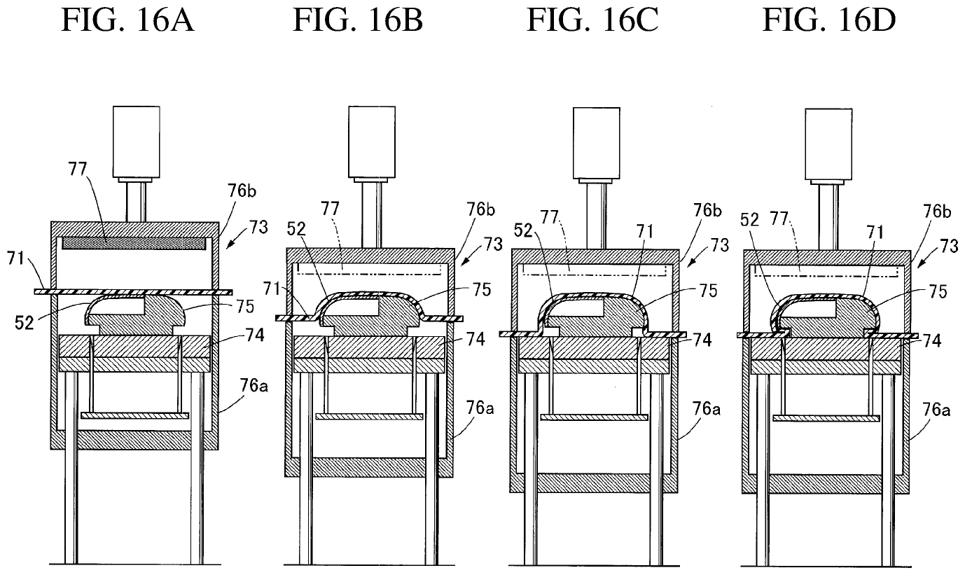

The base body 52 of the front center cowl 23a is installed to a support base 74 of a thermoforming apparatus 73, as illustrated in FIG. 16A. The through-hole portion 58 in the front center cowl 23a is a space. Accordingly, a dedicated jig 75 is installed at the through-hole portion 58 to secure the shape, prior to the installation of the base body 52. An outer surface of the base body 52 and an outer surface of the jig 75 are continuous with each other. The base body 52 of the front center cowl 23a is molded in advance. An example used as the molding is injection molding.

The thermoforming apparatus 73 supports the decorative sheet 71 between a lower frame 76a and an upper frame 76b. The lower frame 76a surrounds the support base 74. The upper frame 76b is on an upper side of the support base 74, and surrounds a heating plate 77. The adhesive 57 is laid on a surface belonging to the decorative sheet 71 and facing the support base 74. The adhesive 57 may be laid on a surface portion that contacts with the base body 52. The heating plate 77 is provided above the decorative sheet 71 so as to be separated from the decorative sheet 71, as illustrated in FIG. 16A. The decorative sheet 71 is thereby heated. The decorative sheet 71 is softened accompanying a temperature rise.

Spaces above and below the decorative sheet 71 are decompressed. Vacuums are secured in the spaces above and below the decorative sheet 71. The decorative sheet 71 is then made to cover the surface of the base body 52 as illustrated in FIG. 16B. At this time, the space above the decorative sheet 71 is opened to the atmosphere. As a result, the decorative sheet 71 comes to conform with and closely contact with the surface of the base body 52 as illustrated in FIG. 16C. Further, when a pressure of the space above the decorative sheet 71 is increased, the decorative sheet 71 is wrapped around the base body 52 from the edge of the base body 52 as illustrated in FIG. 16D. A cutter is then moved upward to cut an unnecessary portion of the decorative sheet 71. A surface of the support plate 62 escapes being covered with the decorative sheet 71. When a temperature of the decorative sheet 71 falls, the decorative sheet 71 is cured. Thus, the skin body 53 is made to cover the surface of the base body 52. Since no adhesive is stuck to a surface portion belonging to the decorative sheet 71 and overlapping with the jig 75, the skin body 46 singly forms the visor 35 as it is so as to conform with an outer surface shape of the jig 75.

The skin body 53 is thus fixed to and integrated with the shell body 54 of the base body 52 so as to cover the shell body 54. Further, the skin body 53 contributes to rigidity of the front center cowl 23a because of an increase in thickness of the decorative sheet 71. Since the skin body 53 contributes to securing rigidity, a resin amount of the front center cowl 23a is reduced by at least an amount of a generally used decorative film. A weight of the front center cowl 23a is reduced. The front center cowl 23a is reduced in weight. Similarly, the front side cowl 23b, the side cowl 24, and the rear cowl 25 are reduced in weight.

A thickness of the skin body 53 is set such that the skin body 53 singly maintain its shape. Thereby, a part of the skin body 53 can function as the visor 35.

The front side cowl 23b includes the skeleton body 51. The skeleton body 51 is arranged at the first density in the first region 61a for which the first rigidity is intended, and is arranged at the second density in the second region 61b for which the second rigidity is intended. The second density is higher than the first density. The second rigidity is higher than the first rigidity. When the direction indicator 40 is coupled to the pedestal 46, the pedestal 46 is intended to have rigidity capable of withstanding support of the direction indicator 40. The intended rigidity is secured while depending on coarseness and fineness of the ribs. Coarseness and fineness of the mesh is thus adjusted depending on locally intended rigidity. The rigidity intended for each local region is secured.

The rear cowl 25 includes the skeleton body 51. The skeleton body 51 is arranged at the first density in the first region 64a for which the first rigidity is intended, and is arranged at the second density in the second region 64b for which the second rigidity is intended. The second density is higher than the first density. The second rigidity is higher than the first rigidity. When the projection 65 is inserted into the insertion hole 66a of the grommet 66, rigidity capable of withstanding vibration of the rear cowl 25 is intended around the projection 65. Coarseness and fineness of the mesh is thus adjusted in the rear cowl 25, depending on locally intended rigidity. The rigidity intended for each local region is secured. The intended rigidity is secured while depending on coarseness and fineness in the skeleton body 51. Coarseness and fineness of the mesh is adjusted depending on locally intended rigidity. The rigidity intended for each local region is secured.

When the front center cowl 23a is coupled to the front side cowl 23b, the ribs 56 of the front side cowl 23b is superposed on the support plate 62 of the front center cowl 23a. A plurality of the convex portions 63 provided on the support plate 62 are fitted, by use of the elastic deformation, into the concave portion 55 surrounded by the ribs 51 in the front side cowl 23b. Then, the front side cowl 23b is made to closely contact with and be coupled to the front center cowl 23a. Accordingly, tighteners such as screws can be omitted in a region where the front center cowl 23a and the front side cowl 23b are superposed on each other, and chattering vibration can be prevented from occurring. Since the outer surface of the front center cowl 23a is maintained as a smooth surface on a back side of the convex portions 63, an appearance of the front cowl 23 is improved.

The similar advantageous effect can be achieved also when a plurality of the convex portions 63 provided on the support plate 62 sandwich both side surfaces of the rib 56 of the front side cowl 23b by use of the elastic deformation. Since the rib 56 is used for the coupling, the number of dedicated coupling members can be reduced, and a degree of freedom of a coupling position is also improved.

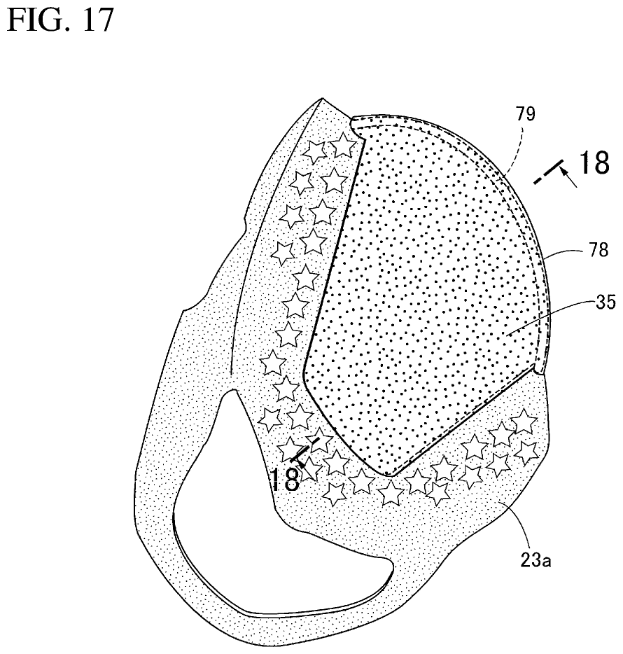

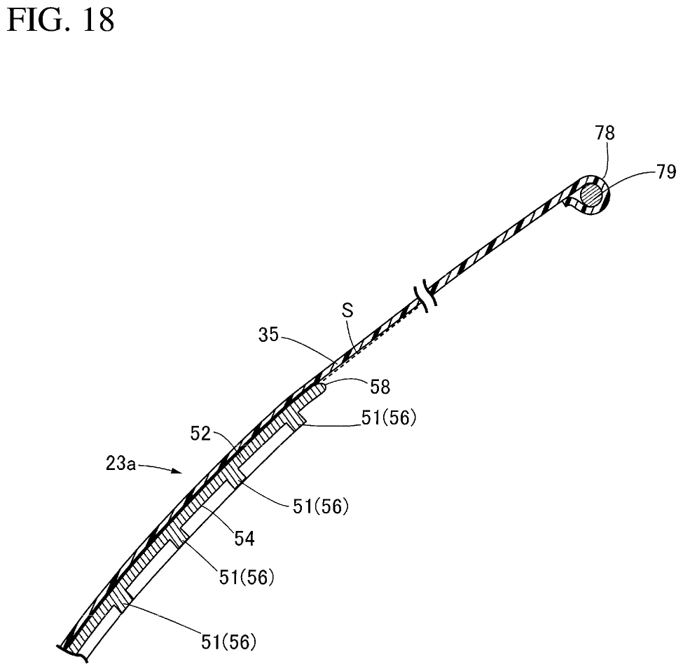

An edge of the visor 35 may be formed as a bead edge 78 as illustrated in FIG. 17. In this case, an arch-shaped core 79 is provided so as to be integrated with the base body 52 of the front center cowl 23a and be along the edge of the visor 35. The decorative sheet 71 is wrapped around the core 79 at the time of the covering with the decorative sheet 71, as illustrated in FIG. 18. The bead edge 78 is thus formed at the edge of the visor 35.

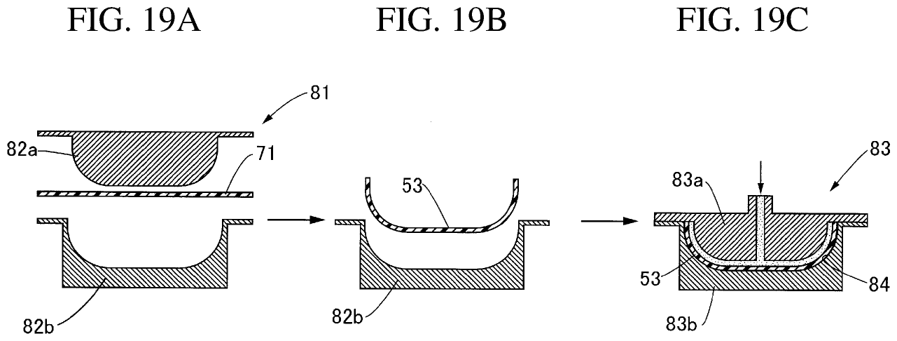

In addition, the cowl 13 may be manufactured by the following manufacturing method instead of by the above-described manufacturing method. Using a mold adapted to an outer shape of the base body 52 in advance enables the decorative sheet 71 to be molded into the skin body 53 by a press molding machine 81, as illustrated in FIG. 19A. The decorative sheet 71 is heated at the time of being molded. The decorative sheet 71 is sandwiched between an upper mold 82a and a lower mold 82b and thereby press-molded in a state where the decorative sheet 71 is softened. The molded decorative sheet 71 is cooled and then taken out from the molds.

The decorative sheet 71 is trimmed along an outline of the skin body 53 as illustrated in FIG. 19B. The skin body 53 is set in an injection molding machine 83 after the trimming. An upper mold 83a and a lower mold 83b are closed as illustrated in FIG. 19C. The lower mold 82b may be held as it is. For example, the upper mold 83a and the lower mold 83b define a cavity 84 for the front center cowl 23a in advance while the upper mold 83a defines cavities suitable for the ribs 51. Injection molding then integrates the skeleton body 51 and the shell body 54 with the inner surface of the skin body 53, thereby manufacturing the front center cowl 23a.

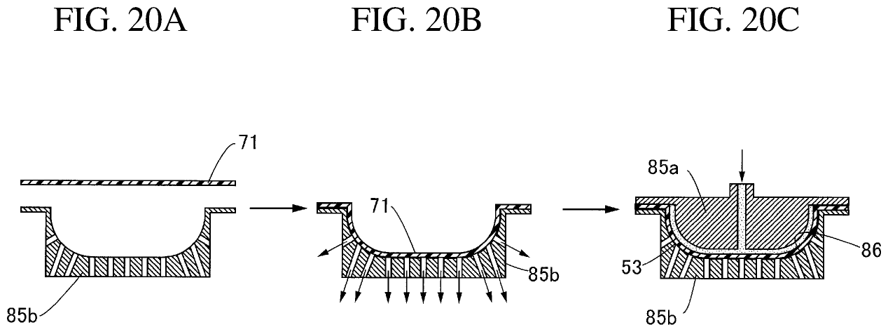

Alternatively, the decorative sheet 71 is set to a lower mold 85b as illustrated in FIG. 20A. A pressure between the decorative sheet 71 and the lower mold 85b is reduced. The decorative sheet 71 comes to conform with the lower mold 85b as illustrated in FIG. 20B. The decorative sheet 71 sticks to an inner surface of a cavity 86. Subsequently, the lower mold 85b and an upper mold 85a that includes cavities for the shell body 54 and the reinforcement ribs 51 are closed as illustrated in FIG. 20C. Injection molding is then performed in the cavity 86. The decorative sheet 71 is removed from the molds, and is then trimmed. The front center cowl 23a is thus manufactured.

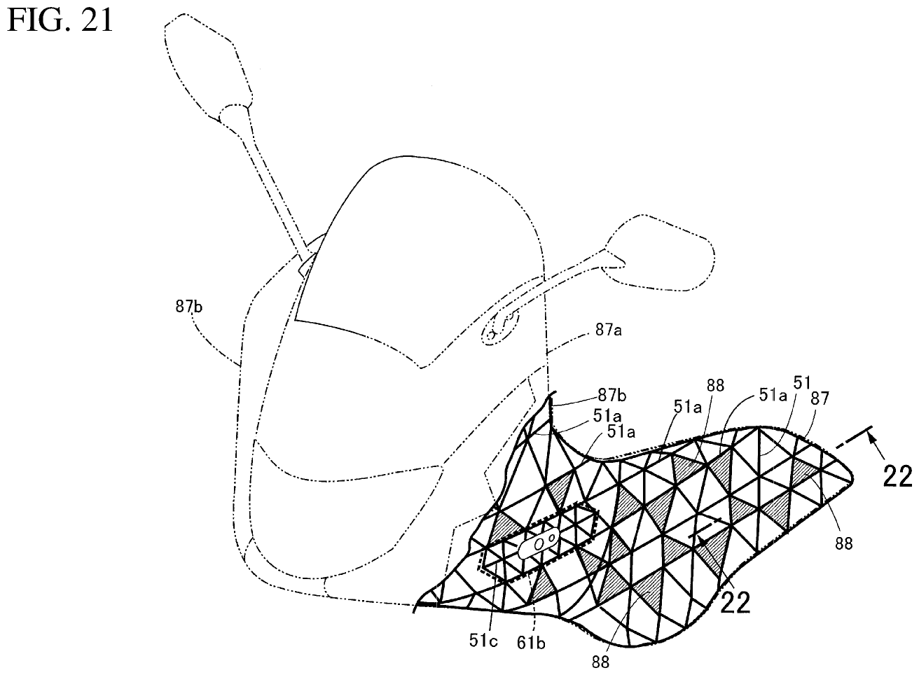

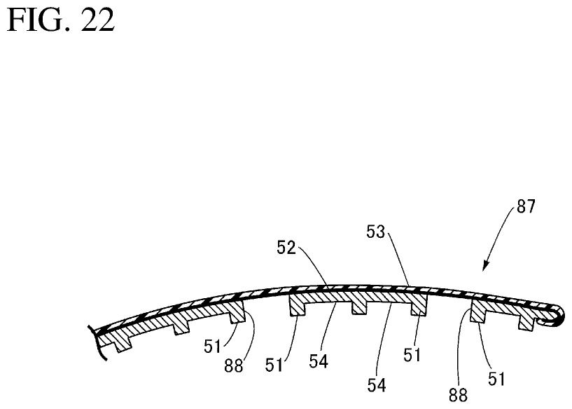

FIG. 21 illustrates arrangement of the skeleton body 51 in a front cowl 87 according to another embodiment. The front cowl 87 includes a front center cowl 87a and front side cowls 87b coupled to left and right portions of the front center cowl 87a, similarly to the above-described front cowl 23. The front cowl 87 includes a base body 52 and a skin body 53. The base body 52 includes a skeleton body 51 spread in a mesh pattern along a matching surface S. The base body 52 singly has rigidity lower than intended rigidity. The skin body 53 includes a colored printed surface. The skin body 53 is fixed to the base body 52 so as to cover the matching surface S. The skin body 53 secures the intended rigidity in cooperation with the base body 52. The base body 52 includes a shell body 54 spreading along the matching surface S so as to occupy in-between spaces at some locations in the skeleton body 51. Spaces 88 that are surrounded by the skeleton body 51 and that exist where the shell body 54 is absent are closed by the skin body 53. The spaces 88 are not limited to those arranged at the locations illustrated in FIG. 22, and can be arranged at a plurality of locations surrounded by the skeleton body 51, as hatched in FIG. 21. The remaining configuration is the same as that of the above-described front cowl 23. The curtailing of the shell body 54 can further reduce a weight of the front cowl 87.

1. A decorative molded article comprising:
a resin-made base body that includes a skeleton body spread in a mesh pattern along a matching surface, the base body singly having rigidity lower than intended rigidity; and
a resin-made skin body that includes a colored printed surface, and is fixed to the base body so as to cover the matching surface, the skin body securing the intended rigidity in cooperation with the base body.

2. The decorative molded article according to claim 1, wherein the base body includes a shell body that spreads along the matching surface so as to occupy an in-between space in the skeleton body, and the skin body has a thickness equal to or larger than a thickness of the shell body.

3. The decorative molded article according to claim 1, wherein the skeleton body is arranged at a first density in a first region for which a first rigidity is intended, and is arranged at a second density in a second region for which a second rigidity is intended, the second density being higher than the first density, the second rigidity being higher than the first rigidity.

4. The decorative molded article according to claim 3, wherein the base body includes a pedestal in the second region, the pedestal having a thickness larger than a thickness of the skeleton body and having an area wider than the skeleton body, along the matching surface.

5. The decorative molded article according to claim 1, wherein the skin body is a layer body that is adhered, with an adhesive, to the matching surface of the base body.

6. The decorative molded article according to claim 5, wherein the layer body is molded from a resin sheet that is made to cover the matching surface by thermoforming.

7. The decorative molded article according to claim 2, wherein the skeleton body is arranged at a first density in a first region for which a first rigidity is intended, and is arranged at a second density in a second region for which a second rigidity is intended, the second density being higher than the first density, the second rigidity being higher than the first rigidity.

8. The decorative molded article according to claim 7, wherein the base body includes a pedestal in the second region, the pedestal having a thickness larger than a thickness of the skeleton body and having an area wider than the skeleton body, along the matching surface.

9. The decorative molded article according to claim 2, wherein the skin body is a layer body that is adhered, with an adhesive, to the matching surface of the base body.

10. The decorative molded article according to claim 3, wherein the skin body is a layer body that is adhered, with an adhesive, to the matching surface of the base body.

11. The decorative molded article according to claim 4, wherein the skin body is a. layer body that is adhered, with an adhesive, to the matching surface of the base body. 12, (New) The decorative molded article according to claim 9, wherein the layer body is molded from a resin sheet that is made to cover the matching surface by thermoforming.

13. The decorative molded article according to claim 10, wherein the layer body is molded from a resin sheet that is made to cover the matching surface by thermoforming.

14. The decorative molded article according to claim 11, wherein the layer body is molded from a resin sheet that is made to cover the matching surface by thermoforming.
